(19) United States
(12) Patent Application Publication
(10) Pub. No.: US 2020/0279195 A1
(43) Pub. Date: Sep. 3, 2020

(54) ON-DEMAND TRANSPORTATION MANAGEMENT SYSTEM

(71) Applicant: Mitsubishi Electric Corporation, Chiyoda-ku (JP)

(72) Inventors: Shingo KOBORI, Tokyo (JP); Koki YOSHIMOTO, Tokyo (JP); Kenji UEDA, Tokyo (JP); Sae KIMURA, Tokyo (JP)

(73) Assignee: Mitsubishi Electric Corporation, Chiyoda-ku (JP)

(21) Appl. No.: 16/648,085

(22) PCT Filed: Nov. 29, 2017
(86) PCT No.: PCT/JP2017/042766

§ 371 Date: Mar. 17, 2020

(51) Int. Cl. G06Q 10/02; G06Q 10/06; G06Q 50/30

(52) U.S. Cl. CPC G06Q 10/02; G06Q 50/30; G06Q 10/06315

(57) ABSTRACT

Provided is an on-demand transportation management system including: a request reception means configured to receive an itinerary request of a plurality of passengers, the itinerary request including at least any one of desired departure time and desired arrival time of a shared on-demand transportation vehicle, a departure point, and a destination; and a vehicle allocation planning means configured to create a vehicle allocation plan of the on-demand transportation vehicle by classifying the plurality of passengers according to a predetermined condition that the itinerary request is received before predetermined time and the desired arrival time or the desired departure time is within a predetermined period of time. A limited number of on-demand transportation vehicles can be efficiently operated, and at the same time, a vehicle allocation plan receiving use requests of a larger number of passengers can be created.

### TECHNICAL FIELD

The present invention relates to an on-demand transportation management system using a shared on-demand transportation vehicle.

### BACKGROUND ART

In Patent Document 1, when the current time approaches desired use time of an on-demand bus included in a use request, vehicle allocation plans are sequentially created, and making a modification later to a previously created vehicle allocation plan is allowed. Further, in Patent Document 2, vehicle allocation plans are sequentially created in response to transmitted use requests. Further, in Patent Document 3, an operation plan of an on-demand transportation vehicle is initially created, a boarding time zone available for reservation is set for each stop, and new use requests are received in the boarding time zone available for reservation.

### PRIOR ART DOCUMENTS

### Patent Documents

Patent Document 1: Japanese Patent Application Laid-Open No. 2011-022646

Patent Document 2: Japanese Patent Application Laid-Open No. 2003-006784

Patent Document 3: Japanese Patent Application Laid-Open No. 2003-288688

### SUMMARY

### Problem to be Solved by the Invention

In Patent Document 1 and Patent Document 2, a vehicle allocation plan is not created by collecting use requests of all the passengers transmitted before predetermined time, nor is the vehicle allocation plan created by classifying the passengers by using the predetermined time. Further, in Patent Document 3, classification between use requests used for creation of the initial operation plan and other use requests is unclear. As described above, creation of a vehicle allocation plan of an on-demand transportation vehicle receiving use requests of a larger number of passengers at the same time as enabling efficient operation of the on-demand transportation vehicle cannot be sufficiently carried out.

### Means to Solve the Problem

Provided is an on-demand transportation management system including: a request reception means configured to receive an itinerary request of a plurality of passengers, the itinerary request including at least any one of desired departure time and desired arrival time, a departure point, and a destination; and a vehicle allocation planning means configured to create a vehicle allocation plan of an on-demand transportation vehicle by classifying the plurality of passengers according to a predetermined condition that the itinerary request is received before predetermined time and the desired arrival time or the desired departure time is within a predetermined period of time.

### Effects of the Invention

According to the present invention, a limited number of on-demand transportation vehicles can be efficiently operated, and at the same time, a vehicle allocation plan receiving use requests of a larger number of passengers can be created.

### BRIEF DESCRIPTION OF DRAWINGS

FIG. 1 is a block diagram of an on-demand transportation management system according to a first embodiment.

FIG. 2 is a diagram illustrating operation of the on-demand transportation management system according to the first embodiment.

FIG. 3 is a diagram illustrating a determination method of passengers according to the first embodiment.

FIG. 4 is a diagram illustrating an outline of operation of a vehicle allocation plan creation process according to the first embodiment.

FIG. 5 is a diagram illustrating an estimation method of passenger candidates according to the first embodiment.

FIG. 6 is a diagram illustrating a fare calculation method according to the first embodiment.

FIG. 7 is a conceptual diagram of a vehicle allocation plan and a traveling route according to the first embodiment.

FIG. 8 is a diagram illustrating a creation method of the vehicle allocation plan according to the first embodiment.

FIG. 9 is a block diagram of the on-demand transportation management system according to the first embodiment.

### DESCRIPTION OF EMBODIMENTS

### First Embodiment

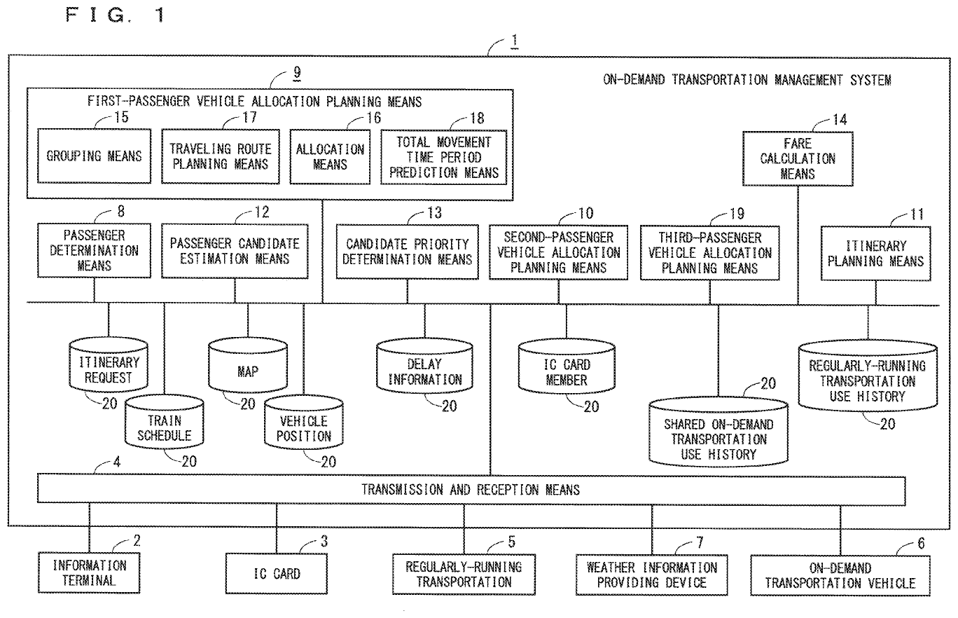

FIG. 1 is a block diagram of an on-demand transportation management system according to a first embodiment of the present invention.

As illustrated in FIG. 1, a passenger being a user exchanges information with an on-demand transportation management system 1 by using an information terminal 2. Here, the information terminal 2 is a terminal capable of exchanging information with a user of on-demand transportation, and examples thereof include a personal computer, a mobile phone, a smartphone, a tablet, and a PDA.

Here, the on-demand transportation is a conveyance of an on-demand transportation system. The on-demand transportation is a reservation-based operation transport service. Further, the on-demand transportation takes a form of providing its service in response to user's demands, and is transportation also referred to as a demand-responsive type.

Further, a shared on-demand transportation vehicle 6 is used as the on-demand transportation. Examples of the shared on-demand transportation vehicle 6 include an on-demand bus and a shared vehicle, of which traveling route and departure time and arrival time at each point vary depending on a passenger's demand. The shared on-demand transportation vehicle 6 is often shortened to an on-demand transportation vehicle 6, both of which refer to the same thing. The shortened expression “on-demand transportation vehicle 6” will be hereinafter used.

For example, the on-demand transportation management system 1 receives an itinerary request including information such as a destination, a departure point, desired arrival time of the on-demand transportation vehicle 6, desired departure time of the on-demand transportation vehicle 6, a boarding station and an alighting station of a regularly-running transportation 5, a boarding point of the on-demand transportation vehicle 6, and an alighting point of the on-demand transportation vehicle 6, from the information terminal 2 via a transmission and reception means 4. Note that the transmission and reception means 4 receives and transmits information between the on-demand transportation management system 1 and an external device, a device, a vehicle, etc. For example, the transmission and reception means 4 receives and transmits information to and from an information terminal 2, an IC card 3, a regularly-running transportation 5, an on-demand transportation vehicle 6, and a weather information providing device 7, as well as with a management device that manages those above.

In the following description, an itinerary including a transfer between the on-demand transportation vehicle 6 and the regularly-running transportation 5 is assumed, and it is assumed that one of a destination and a departure point is a departure/destination point of the on-demand transportation vehicle 6 and the other is a departure/destination point of the regularly-running transportation 5. There may not be a transfer between the on-demand transportation vehicle 6 and the regularly-running transportation 5, and both the destination and the departure point may be a departure/destination point of the on-demand transportation vehicle 6. In other words, possible cases may be roughly classified into a case including a transfer from the regularly-running transportation 5 as a departure point to the on-demand transportation vehicle 6 as a destination, a case including a transfer from the on-demand transportation vehicle 6 as a departure point to the regularly-running transportation 5 as a destination, and a case only using the on-demand transportation vehicle 6.

For example, the information terminal 2 receives a boarding station, departure time, an alighting station, and arrival time of a regularly-running transportation 5 to be boarded, and a boarding point, an identifier of a vehicle, departure time, an alighting point, arrival time, and a fare of an on-demand transportation vehicle 6 to be boarded, from the transmission and reception means 4 serving as a request reception means.

As illustrated in FIG. 1, the on-demand transportation management system 1 and the IC card 3 held by a user exchange information. For example, the on-demand transportation management system 1 receives IC card member information including an identifier such as a member's name and a membership number, an address, a date of birth, age, contact information such as a telephone number and an e-mail address, a boarding station and an alighting station of a designated area of a commuter pass of the regularly-running transportation 5, a ticket gate passage history in stations, etc., from the IC card 3 via the transmission and reception means 4. Here, all of such pieces of information need not be directly received from the IC card 3. If a management device of the IC card 3 manages the IC card member information, the on-demand transportation management system 1 may acquire the IC card member information from the management device of the IC card 3. In this case, information is received from the management device of the IC card 3 via the transmission and reception means 4.

By receiving information from the management device of the IC card 3 or from the IC card 3, the on-demand transportation management system 1 can obtain information such as boarding frequency according to the IC card 3, a registered age in the IC card 3, and a movement distance according to the regularly-running transportation 5. Further, a use history of a passenger can be obtained based on use time of the IC card, which can be used as a ticket for the regularly-running transportation 5.

As illustrated in FIG. 1, the on-demand transportation management system 1 and the regularly-running transportation 5 exchange information. Note that the regularly-running transportation 5 is transportation that provides its service according to a predetermined timetable, and examples thereof include a train, bus rapid transit (BRT), light rail transit (LRT), a bus, and an airplane. Although the term “vehicle” is herein used in description taking an example of the regularly-running transportation 5 for the sake of convenience, the term “vehicle” refers to a body of an airplane when the description refers to an airplane.

For example, the on-demand transportation management system 1 receives a position of a vehicle, a timetable, a running plan, delay information, a map, etc. from the regularly-running transportation 5. Here, all of such pieces of information need not be directly received from the regularly-running transportation 5. If a management device of the regularly-running transportation 5 manages the above pieces of information, the on-demand transportation management system 1 may acquire the above pieces of information from the management device of the regularly-running transportation 5. In many cases, the service of the regularly-running transportation 5 is managed by the management device.

As illustrated in FIG. 1, the on-demand transportation management system 1 and the on-demand transportation vehicle 6 exchange information. For example, the on-demand transportation management system 1 receives a position of a vehicle, a running plan, delay information, a map, etc. from the on-demand transportation vehicle 6. Here, all of such pieces of information need not be directly received from the on-demand transportation vehicle 6. If a management device of the on-demand transportation vehicle 6 manages the above pieces of information, the on-demand transportation management system 1 may acquire the above pieces of information from the management device of on-demand transportation vehicle 6. Further, the management device of the on-demand transportation vehicle 6 may be included in the on-demand transportation management system 1.

For example, the on-demand transportation vehicle 6 receives a vehicle allocation plan including arrival time and departure time of each vehicle stop point, a traveling route between vehicle stop points, the number of passengers at each vehicle stop point, an identifier such as a name, gender, age, a disability if any and an alighting point of the passengers, etc., from the on-demand transportation management system 1.

As illustrated in FIG. 1, the on-demand transportation management system 1 and the weather information providing device 7 exchange information. For example, the on-demand transportation management system 1 receives weather, temperature, probability of precipitation, the amount of precipitation, various advisories, various warnings, forecasts for those items, etc. of a boarding and alighting area of the on-demand transportation vehicle 6 and the regularly-running transportation 5, from the weather information providing device 7.

The on-demand transportation management system 1 includes a passenger determination means 8, a first-passenger vehicle allocation planning means 9, a second-passenger vehicle allocation planning means 10, a third-passenger vehicle allocation planning means 19, an itinerary planning means 11, a passenger candidate estimation means 12, a candidate priority determination means 13, a fare calculation means 14, a transmission and reception means 4, and a database 20, each of which is connected to be capable of exchanging information.

The database 20, which includes storage devices such as a main storage device, an auxiliary storage device, and an external storage device, stores, for example, an itinerary request of a passenger, a train schedule, a map, a vehicle position of the on-demand transportation vehicle 6 and the regularly-running transportation 5, delay information of the regularly-running transportation 5, member information of the IC card 3, a use history of the on-demand transportation vehicle 6, a use history of the regularly-running transportation 5, etc. Further, the components of the on-demand transportation management system 1 other than the transmission and reception means 4 and the database 20 are implemented as internal arithmetic processing of a computer by using a CPU.

The passenger determination means 8 makes a determination regarding a plurality of passengers who have an itinerary request with its desired arrival time for a destination and desired boarding time for the on-demand transportation vehicle 6 falling within a predetermined period of time, and classifies the plurality of passengers into first passengers (high-priority passengers), who transmitted the itinerary request by predetermined time, and second passengers (general passengers), who transmitted the itinerary request after the predetermined time. The passenger determination means 8 classifies the passengers into the high-priority passengers (first passengers) and the general passengers (second passengers), according to a predetermined condition that the itinerary request is received before the predetermined time and the desired arrival time or the desired departure time is within the predetermined period of time.

The first-passenger vehicle allocation planning means 9 receives from the information terminal 2, and creates a vehicle allocation plan of the on-demand transportation vehicle 6, based on collected itinerary requests of the first passengers. The first-passenger vehicle allocation planning means 9 includes a grouping means 15. The grouping means 15 divides the plurality of first passengers, from whom the itinerary requests are received, into groups consisting of a plurality of first passengers (or a single first passenger in some cases).

The first-passenger vehicle allocation planning means 9 includes an allocation means 16. The allocation means 16 determines an on-demand transportation vehicle 6 to carry the group consisting of a plurality of passengers. The first-passenger vehicle allocation planning means 9 includes a traveling route planning means 17. The traveling route planning means 17 creates a running plan of the on-demand transportation vehicle 6 including a traveling route between stop points, a traveling time period, and arrival time and departure time at each stop point, based on the itinerary requests of the group consisting of a plurality of passengers.

The first-passenger vehicle allocation planning means 9 includes a total movement time period prediction means 18. The total movement time period prediction means 18 predicts a total movement time period including a total of a boarding time period of the regularly-running transportation 5, a waiting time period of the on-demand transportation vehicle 6, and a boarding time period of the on-demand transportation vehicle 6 of the passengers, based on the running plan, the itinerary requests, and the timetable of the regularly-running transportation 5. The total movement time period prediction means 18 predicts a total time period taken from when the high-priority passengers being the first passengers leave a departure point to when the high-priority passengers reach a destination.

The second-passenger vehicle allocation planning means 10 creates a vehicle allocation plan of the on-demand transportation vehicle 6, based on the itinerary requests of the second passengers received from the information terminal 2.

The passenger candidate estimation means 12 estimates passenger candidates of the on-demand transportation vehicle 6, based on member information of the IC card 3. Further, the candidate priority determination means 13 determines the order of suggesting the use of the on-demand transportation vehicle 6 among the passenger candidates estimated by the passenger candidate estimation means 12.

The itinerary planning means 11 creates an itinerary of each passenger for the regularly-running transportation 5 and the on-demand transportation vehicle 6 combined, based on information such as the running plan of the on-demand transportation vehicle 6 and the timetable of the regularly-running transportation 5. Further, the fare calculation means 14 determines the fare for the first passengers, the second passengers, and the like, based on individual formulas.

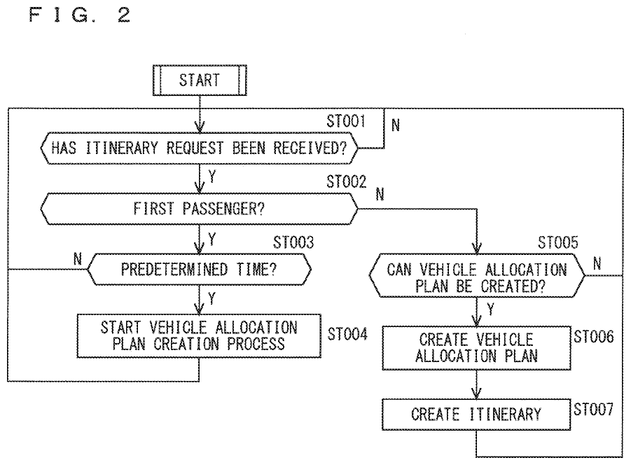

FIG. 2 is a diagram illustrating an outline of operation of the on-demand transportation management system 1. In Step ST001, the on-demand transportation management system 1 waits for reception of the itinerary request for the transmission and reception means 4 from the information terminal 2. If the itinerary request is received, the process proceeds to Step ST002.

In Step ST002, the passenger determination means 8 determines whether the passenger is a first passenger (high-priority passenger) or a second passenger (general passenger), according to the received itinerary request. If the passenger is a first passenger, the process proceeds to Step ST003. If the passenger is a second passenger, the process proceeds to Step ST005.

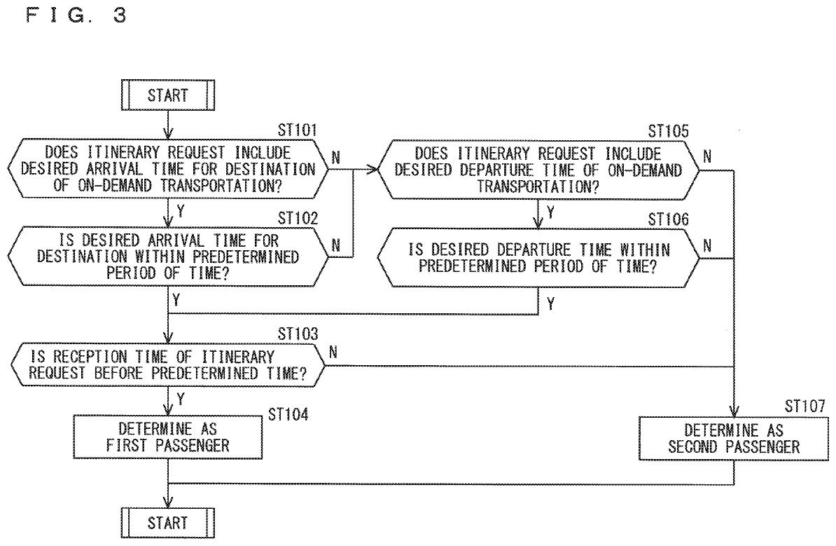

FIG. 3 is a diagram illustrating a determination method used by the passenger determination means 8 to determine whether the passenger is a first passenger or a second passenger. For example, a period of time from 8 am to 9 am of the current day is defined as a predetermined period of time, and 9 pm of the previous day is defined as predetermined time. If an itinerary request with the desired arrival time for the destination at 8:25 am is received at 7 pm on the previous day, reception is accepted with the desired arrival time falling within the predetermined period of time and before the predetermined time. Thus, it is determined that the passenger who transmitted the itinerary request is a first passenger. In contrast, if an itinerary request with the desired arrival time for the destination at 8:25 am is received later than 9 pm on the previous day, it is determined that the passenger who transmitted the itinerary request is a second passenger.

The condition included in the itinerary request may be the desired departure time of the on-demand transportation vehicle 6 or the regularly-running transportation 5, instead of the desired arrival time for the destination. Note that the predetermined period of time and the predetermined time may be set for each stop point of the on-demand transportation vehicle 6, or may be set to be common to all the stop points. Further, a plurality of predetermined periods of time and predetermined times may be determined.

In Step ST101, whether the itinerary request of the passenger applicant includes desired arrival time for the destination of the on-demand transportation vehicle 6 is confirmed. If the itinerary request includes desired arrival time, the process proceeds to Step ST102; otherwise, the process proceeds to Step ST105.

In Step ST102, whether the desired arrival time for the destination is within the predetermined period of time is confirmed. If the desired arrival time is within the predetermined period of time, the process proceeds to Step ST103; otherwise, the process proceeds to Step ST105.

In Step ST103, whether reception time of the itinerary request is before the predetermined time is confirmed. If the reception time is before the predetermined time, the process proceeds to Step ST104, and it is determined that the passenger is a first passenger (high-priority passenger). In contrast, if the reception time is after the predetermined time, the process proceeds to Step ST107, and it is determined that the passenger is a second passenger (general passenger).

In Step ST105, whether there the itinerary request includes desired departure time for the destination of the on-demand transportation vehicle 6 is confirmed. If the itinerary request includes desired departure time, the process proceeds to Step ST106; otherwise, the process proceeds to Step ST107, and it is determined that the passenger is a second passenger (general passenger).

In Step ST106, whether the desired departure time is within the predetermined period of time is confirmed. If the desired departure time is within the predetermined period of time, the process proceeds to Step ST103; otherwise, the process proceeds to Step ST107, and it is determined that the passenger is a second passenger (general passenger).

FIG. 3 illustrates an example of the determination method used by the passenger determination means 8 to determine whether the passenger is a first passenger or a second passenger. However, the determination method may be freely modified, such as by performing Step ST103 immediately after the start.

Further, the passengers may be classified according to a predetermined condition that itinerary requests of a plurality of passengers including at least one of the desired departure time and the desired arrival time of the on-demand transportation vehicle 6, the departure point, and the destination are received by the transmission and reception means 4 (request reception means), the itinerary requests are received before the predetermined time, and the desired arrival time or the desired departure time is within the predetermined period of time. The high-priority passenger satisfying the predetermined condition is a first passenger, and the general passenger not satisfying the predetermined condition is a second passenger.

In Step ST003 of FIG. 2, itinerary requests of the first passengers are collected until the predetermined time. After the predetermined time passes, the process proceeds to Step ST004, and the process returns to Step ST001 until the predetermined time.

In Step ST004, the passenger determination means 8 starts a first-passenger vehicle allocation plan creation process.

If it is determined that the passenger is a second passenger in Step ST002, in Step ST005, the second-passenger vehicle allocation planning means 10 determines whether a vehicle allocation plan can be created. If the vehicle allocation plan can be created, the process proceeds to Step ST006. If the vehicle allocation plan cannot be created, the process returns to Step ST001.

Here, at the time point of Step ST005, the vehicle allocation plan for the first passengers is already created in Step ST004. This is because the vehicle allocation plan for the first passenger is normally created before the predetermined time, whereas the vehicle allocation plan for the second passengers is created after the predetermined time. The itinerary request of the first passenger includes a condition such as the desired arrival time and the desired departure time. In the first-passenger vehicle allocation plan creation process started in Step ST004, the vehicle allocation plan or the itinerary is created so as to satisfy the condition.

Therefore, as for the itinerary request of the second passenger, the second passenger will be added to the vehicle allocation plan created in Step ST004. If the condition of the itinerary request of the first passenger and the itinerary condition of the second passenger cannot be satisfied, the second passenger cannot be added to the vehicle allocation plan of the on-demand transportation vehicle 6. If the second passenger cannot be added to any vehicle allocation plan of the on-demand transportation vehicle 6, it is determined that a vehicle allocation plan for the second passenger cannot be created.

In the determination as to whether the condition of the itinerary request of each passenger can be satisfied, the itinerary request of the second passenger is incorporated into an existing vehicle allocation plan. In this case, there are a plurality of orders of vehicle stop points of the on-demand transportation vehicle 6, i.e., traveling routes, and thus it is determined whether the condition can be satisfied concerning all of those traveling routes.

In Step ST006, the second-passenger vehicle allocation planning means 10 creates a vehicle allocation plan for the itinerary request of the second passenger.

If there is a vehicle allocation plan that can satisfy the conditions of the itinerary requests of all the passengers, whether there are other vehicle allocation plans that can satisfy the conditions are searched. Among such vehicle allocation plans that can satisfy the conditions, a vehicle allocation plan that optimizes a predetermined evaluation index is selected as the vehicle allocation plan for the itinerary request of the second passenger. The predetermined evaluation index is, for example, the total movement time period described above.

In Step ST007, the on-demand transportation management system 1 transmits the created itinerary to the information terminal 2 of the second passenger via the transmission and reception means 4, and the process returns to Step ST001.

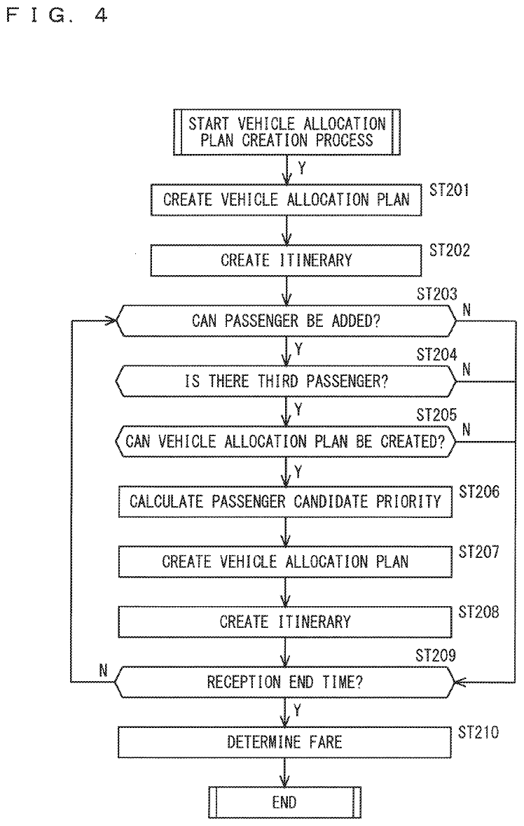

FIG. 4 is a diagram illustrating an outline of operation of the vehicle allocation plan creation process. In Step ST201, the first-passenger vehicle allocation planning means 9 creates a first-passenger vehicle allocation plan. Further, in Step ST202, the on-demand transportation management system 1 transmits the created itinerary to the information terminal 2 of the first passenger via the transmission and reception means 4.

In Step ST203, the first-passenger vehicle allocation planning means 9 determines whether a new passenger can be added to the vehicle allocation plan or the itinerary including passenger A and passenger B, for example. If the passenger can be added, the process proceeds to Step ST204. If the passenger cannot be added, the process proceeds to Step ST209.

For example, passenger capacity of the on-demand transportation vehicle 6 and the number of passengers are compared at each stop point of the on-demand transportation vehicle 6, and it is determined whether an additional passenger can board the on-demand transportation vehicle 6 at the stop point.

In Step ST204, the passenger candidate estimation means 12 estimates passenger candidates (third passengers) of the on-demand transportation vehicle 6, based on member information of the IC card 3. If there is a third passenger, the process proceeds to Step ST205. If there is not a third passenger, the process proceeds to Step ST209.

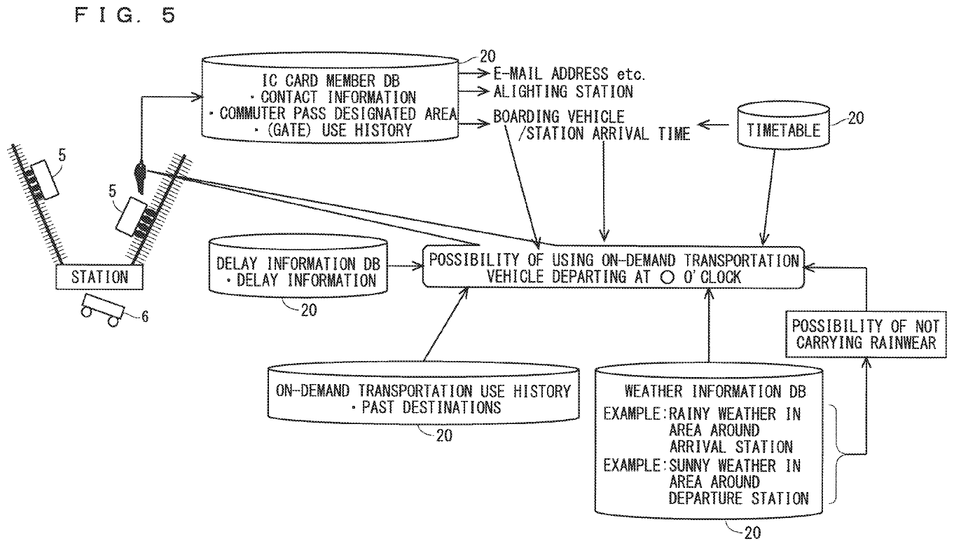

FIG. 5 is a diagram illustrating an estimation method used by the passenger candidate estimation means 12 to estimate passenger candidates. For example, if there is an on-demand transportation vehicle 6 that is scheduled to depart from a station of a stop point of a train being a regularly-running transportation 5, passenger candidates who may be boarding a train vehicle that arrives before scheduled departure time of the on-demand transportation vehicle 6 are estimated.

The passenger candidate estimation means 12 uses the database 20 to estimate passenger candidates of the on-demand transportation vehicle 6 from among persons boarding the regularly-running transportation 5 with the use of the IC card 3 pre-registered as a member when using the regularly-running transportation 5, out of the passengers using the train being the regularly-running transportation 5.

The database 20 stores member information of the IC card 3, and stores, for example, contact information of a member, a designated area of a commuter pass of the regularly-running transportation 5, a use history, a passed ticket gate, passage time, etc. Further, the database 20 stores delay information and a timetable of the regularly-running transportation 5. Further, the database 20 stores a use history (past destinations, use time, etc.) of the on-demand transportation vehicle 6, used by the member of the IC card 3. Further, the database 20 stores weather information of an area around a departure station and an area around an arrival station. Based on these pieces of information of the database 20, for example, the passenger candidate estimation means 12 estimates an e-mail address, an alighting station, a boarding vehicle (for example, whether the boarding vehicle is a local train or a special express train), station arrival time and a possibility of not carrying rainwear, regarding the member of the IC card 3.

For example, a departure point of the on-demand transportation vehicle 6 that is also a stop point of the regularly-running transportation 5 is defined as a departure point S. First, as the member information of the IC card 3, members of the IC cards 3 whose stations at the end of the designated area of the commuter pass of the regularly-running transportation 5 (which are usually boarding and alighting stations) are the departure point S are searched. The member is defined as a member A. Next, based on a passage history and a passage time zone of the ticket gate of each station in the past, members who may alight at the departure point S are searched. The member is defined as a member B.

Among the members A and the members B, a member who may be boarding a train vehicle that arrives at the departure point S before scheduled departure time of the on-demand transportation vehicle 6 is searched. The member is defined as a third passenger, and the train vehicle is defined as a train vehicle R1.

The train vehicle R1 can be determined based on the database 20 of the timetable of the train. Further, a starting station, departure time, stops, and departure/arrival time of the train vehicle R1 can also be calculated based on the database 20 of the timetable. Further, if there is a possibility that a passenger transfers to the train vehicle R1, a transfer station for the train vehicle R1 and a train vehicle R2 before transferring that arrives before the time when the train vehicle R1 departs from the transfer station can also be calculated based on the timetable. At the transfer station, the passenger transfers from the train vehicle R2 to the train vehicle R1. In a similar manner, a starting station, departure time, stops, and arrival time of the train vehicle R2 can also be calculated based on the database 20 of the timetable. At the transfer station, train vehicles often wait for arrival of another train vehicle such as for allowing a transfer from a local train to an express train, as well as at a terminal station.

Although the description herein takes an example of a train vehicle, the regularly-running transportation 5 can calculate boarding and alighting points where the regularly-running transportation 5 has its passenger board the regularly-running transportation 5 and alight from the regularly-running transportation 5, and boarding and alighting start time (for example, arrival time) and boarding and alighting end time (for example, departure time) for each boarding and alighting point, based on the timetable of the database 20. Further, in addition to the information of the timetable, delay information of the database 20 can also be used. The delay information is essential particularly when the regularly-running transportation 5 is an airplane.

The third passenger is a passenger candidate detected by a company of the shared on-demand transportation and who may use the on-demand transportation vehicle 6. The third passenger is a passenger candidate different from the first passenger and the second passenger. The third passenger is a member of the IC card 3 who may have boarded the train vehicle R1 or R2, and is a passenger whose passage time T0 in the ticket gate passage history is earlier than the departure time (arrival time) of the train vehicle R1 or R2 that stops at a station in the passage history. This is because if the ticket gate passage time is later than the departure time (arrival time) of the train vehicle R1 or R2, the passenger cannot board the train vehicle R1 or R2.

Even though the passage time T0 is earlier than the departure time of the train vehicle R1 or R2, a difference of a predetermined time period T1 occurs, because it takes time to actually board the train vehicle after the passage through the ticket gate. Note that such a difference depends on a structure etc. of the station, and thus cannot be uniformly determined.

For example, if there is a train vehicle R3 that departs before the departure time of the train vehicle R1 or R2 stopping at a station in the ticket gate passage history, and the passage time T0 in the passage history is earlier than the departure time of the train vehicle R3 by a predetermined time period T3 or more, the passenger may be boarding on the train vehicle R3 that has departed first, instead of the train vehicle R1 or R2, and thus the passenger may be removed from the third passengers.

If the train vehicle R3 does not stop at a station corresponding to the departure point S of the on-demand transportation vehicle 6, the passenger is not a third passenger. Further, if the train vehicle R1 arrives at the departure point S of the on-demand transportation vehicle 6 earlier than the train vehicle R3 that must have departed before the train vehicle R1 (for example, the train vehicle R1 is an express train and the train vehicle R3 is a local train), the passenger is a third passenger.

If the station yard is large, the passenger may fail to board the train vehicle R1 or R2, unless the passage time T0 in the ticket gate passage history is sufficiently earlier than the departure time (arrival time) of the train vehicle R1 or R2 stopping at a station in the passage history. Therefore, a condition that the passage time T0 in the passage history is earlier than the departure time of the train vehicle R1 or R2 stopping at a station in the passage history by a predetermined time period T1 or more may be added to the condition of classifying the passenger as a third passenger. For example, the predetermined time period T1 may be a walking time period taken from the ticket gate to the platform of the train vehicle R1 or R2.

If there are a plurality of ticket gates, the predetermined time period T1 may be changed depending on a passed ticket gate, because the walking time period varies depending on a passed ticket gate. The passed ticket gate can be calculated based on the ticket gate passage history (history of the IC card 3).

If the use time of the IC card 3 at the departure point is earlier than the time when a first regularly-running transportation 5 departs from the departure point by a first predetermined time period (T1), and the departure time of the on-demand transportation vehicle 6 is later than the time when the first regularly-running transportation 5 arrives at the departure point of the on-demand transportation vehicle 6 by a second predetermined time period (T2), the passenger candidate estimation means 12 classifies the user of the first regularly-running transportation 5 as a first passenger candidate.

If the use time of the IC card 3 at the departure point is earlier than the time when a second regularly-running transportation 5 departs from the departure point by a third predetermined time period (T3), the second regularly-running transportation 5 departs from the departure point earlier than the first regularly-running transportation 5, and the departure time of the on-demand transportation vehicle 6 is later than the time when the second regularly-running transportation 5 arrives at the departure point of the on-demand transportation vehicle 6 by a fourth predetermined time period (T4), the passenger candidate estimation means 12 removes the user of the second regularly-running transportation 5 from the first passenger candidate.

The walking time period may be calculated assuming that a standard walking path length from a ticket gate to a platform is walked at a standard walking speed. For example, the standard walking path length is 50 m and the standard walking speed is 1 m/sec. In this case, the walking time period can be calculated by: 50 sec=standard walking path length/standard walking speed=50/1.

The walking time period varies depending on the degree of congestion in the station yard. The degree of congestion at the station is represented by C₁ using a real number from 0 to 1, with a number closer to 1 representing a higher degree of congestion. In this case, the walking time period can be calculated so as to reflect the degree of congestion in the station yard, such as by “(standard walking path length/standard walking speed)×(1/(1−C₁))”.

The degree of congestion in the station yard is proportional to the number of people in the station yard. Therefore, the degree of congestion C₁ is calculated as in the following formulas, for example. Note that C₁ in the lower formula may take a maximum value exceeding 1.

C₁=(current number of people in station yard)/(maximum number of people in station yard in past)

or

C₁=(current number of people in station yard)/(standard or maximum number of people in station yard assumed in designing of station)

The number of people in the station yard can be calculated by subtracting the sum of the number of exiting people passing through the ticket gate and the number of boarding people on a departed train vehicle from the sum of the number of entering people passing through the ticket gate and the number of alighting people from an arrived train vehicle.

The number of entering people and the number of exiting people passing through the ticket gate can be calculated based on the ticket gate passage history. The number of boarding people on the train vehicle can be calculated in a similar manner to the method of calculating the third passengers. The number of alighting people from the train vehicle can be calculated based on the timetable of the train vehicle, alighting station information of the commuter pass in the member information of the IC card 3, a past alighting history, etc.

Even if the station yard is congested, such congestion only slightly affects the walking time period, provided that a path between the ticket gate and a target platform is not congested. The degree of congestion between the ticket gate and the target platform is represented by C₂ using a real number from 0 to 1, with a number closer to 1 representing a higher degree of congestion. In this case, the walking time period can be calculated so as to reflect the degree of congestion between the ticket gate and the target platform, such as by “(standard walking path length/standard walking speed)×(1/(1−C₂))”.

The degree of congestion of the path between the ticket gate and the target platform is proportional to the number of walking people in the path between the ticket gate and the target platform. The number of walking people in the path between the ticket gate to the target platform can be calculated based on the number of boarding people and the number of alighting people of train vehicles departing and arriving in the target platform, and the number of boarding people and the number of alighting people of train vehicles departing and arriving in another platform that also uses the path between the ticket gate and the target platform. The number of boarding people and the number of alighting people of each train vehicle can be calculated in a similar manner to the method of calculating the number of boarding people and the number of alighting people of each train vehicle necessary for calculation of the number of people in the station yard.

Further, if a system that measures the number of people in the station yard, the walking speed, the walking time period, the positions of people, the number of walking people in the path from the ticket gate to the target platform, the walking speed thereof, the walking time period thereof, and the positions of people thereof is installed, the walking time period may be calculated using those values, and the third passengers may be calculated.

Further, if there is a shop or the like in the station yard, goods can be purchased using the IC card 3, and a purchase history at the shop can be used, the passenger is at the shop at purchase time in the purchase history, and thus the third passenger may be calculated based on the purchase time, the position of the shop, the path to the target platform, etc.

If there is delay in the train operation, a train vehicle R4, which originally can arrive at time earlier than the train vehicle R1 or R2 in normal operation, may arrive at the departure point S of the on-demand transportation vehicle 6 late. Passengers who may be boarding on the train vehicle R4 can also be estimated in a similar manner to estimating the passengers who may be boarding on the train vehicle R1i or R2. Therefore, if there is delay in a train being the regularly-running transportation 5, the passengers who may be boarding on the train vehicle R4 can also be classified as third passengers. The delay of a train is received from an operation management system or the like as delay information of the train via the transmission and reception means 4.

The passenger candidate estimation means 12 regards the third passengers as passenger candidates. Unlike the first passengers and the second passengers who transmitted the itinerary requests on their own, itinerary requests of the passenger candidates (third passengers) are unclear. Therefore, the itinerary requests of the passenger candidates are estimated based on the degree of probability.

For example, the itinerary requests of the passenger candidates can be estimated according to the following method. The departure point of the on-demand transportation vehicle 6 is defined as a departure point S. The departure point S is near the station where the passenger candidate (third passenger) alights from the regularly-running transportation 5. Because the passenger candidate does not apply for the use of the on-demand transportation vehicle 6, it is in many cases assumed that the passenger candidate moves from the departure point S to the destination by other movement means including walking. Therefore, the desired departure time of the passenger candidate can be estimated based on the arrival time at the departure point S.

Further, the on-demand transportation vehicle 6 is an automobile such as a bus and a car, which is assumed to be a fastest-level movement means as a trackless movement means on the ground. Therefore, it is likely that the on-demand transportation vehicle 6 can arrive at earlier time than the original desired arrival time for the destination. Thus, it can be regarded that the desired arrival time does not matter.

Further, if the closest station of the address in the member information of the IC card 3 is the departure point S, the address is estimated as the destination. The address may be inferred from the telephone number in the member information of the IC card 3. Further, if the passenger candidate has used the on-demand transportation vehicle 6 in the past and there is a use history of the on-demand transportation vehicle 6, the destination is estimated based on the use history. Further, even if there is no use history, a destination most selected as the destination from the departure point S is estimated as the destination of the passenger candidate.

In Step ST205 of FIG. 4, the third-passenger vehicle allocation planning means 19 determines whether a vehicle allocation plan can be created for the passenger candidate, in a similar manner to Step ST005 of FIG. 2. If the vehicle allocation plan can be created, the process proceeds to Step ST206. If the vehicle allocation plan cannot be created, the process proceeds to Step ST209.

In Step ST206, the candidate priority determination means 13 determines priority of suggesting the use of the on-demand transportation vehicle 6 among the passenger candidates.

The passenger capacity of the on-demand transportation vehicle 6 is limited, and thus the use of the on-demand transportation vehicle 6 cannot be suggested to all the passenger candidates. A reply indicating the use of the on-demand transportation vehicle 6 from the passenger candidate to whom the use is suggested is required, and the reply needs to be waited for until the reception end time of the reply. Time passes while the reply is waited for, and the departure time of the on-demand transportation vehicle 6 approaches. Accordingly, the number of passenger candidates the use can be suggested is also limited. Therefore, the use needs to be preferentially suggested to a passenger candidate who is more likely to use. An index referred to when determining priority of the passenger candidates and its determination method will be described below.

<Destination>

For example, if an assumed destination is different from the original destination of the passenger candidate, it is less likely that the passenger candidate uses the suggested on-demand transportation vehicle 6. Therefore, different degrees of priority of use suggestion are assigned to passenger candidates whose destination is estimated as the address, passenger candidates whose destination is estimated based on the past use history of the on-demand transportation vehicle 6, and other passenger candidates. For example, the priority is set so that the passenger candidates whose destination is the address are assigned priority 1, the passenger candidates whose destination is estimated based on the use history are assigned priority 2, and other passenger candidates are assigned priority 3. In this example, priority 3 has the lowest degree of use suggestion and priority 1 the highest. In the following description, the smaller the number assigned for the priority is, the higher the priority is.

<Delay>

For example, a passenger candidate who has been boarding on a delayed regularly-running transportation 5 has their original itinerary behind schedule, and thus it is likely that the passenger fails to be in time for the original desired arrival time for the destination. Therefore, it is likely that the passenger uses the on-demand transportation vehicle 6 to make up for the delayed itinerary. Therefore, different degrees of priority of use suggestion are assigned to passenger candidates who have been boarding on the delayed regularly-running transportation 5, and other passenger candidates. For example, the priority is set so that the passenger candidates with significant delay in the itinerary are assigned priority 1, the passenger candidates with slight delay in the itinerary are assigned priority 2, and other passenger candidates are assigned priority 3. Further, the priority may be a function according to the delay in the itinerary.

<Weather>

For example, if the current weather in an area around the departure point S is rainy and the weather in an area around the boarding station where the passenger candidate boarded on the regularly-running transportation 5 at the time point of the boarding time is not rainy based on weather information received from the weather information providing device 7, the passenger candidate may not carry rainwear. It is likely that the passenger candidate who does not carry rainwear uses the on-demand transportation vehicle 6 to move to the destination. Therefore, if the current weather in an area around the departure point S is rainy, different degrees of priority of use suggestion are assigned to passenger candidates with weather in an area around the boarding station where the passenger candidates boarded on the regularly-running transportation 5 at the time point of the boarding time being rainy, and other passenger candidates. Further, different degrees of priority may be assigned for heavy rain and light rain, and the priority may be a function that depends on a difference in the amount of precipitation.

Further, if the departure point S is the closest station of the address of the passenger candidate, the destination from the departure point S may be the address, and the passenger candidate may return home in this situation. If the weather in an area around the address or around the departure point S at the time of departure from a residence located in the address or at the ticket gate passage time at the departure point S is not rainy and the weather in an area around the current address or around the departure point S is rainy, the passenger candidate may not carry rainwear. Therefore, if the current weather in an area around the departure point S is rainy, different degrees of priority of use suggestion are assigned to passenger candidates with weather in an area around the address or around the departure point S at the time of departure from a residence located in the address or at the ticket gate passage time at the departure point S being rainy, and other passenger candidates. For example, the priority is set so that the passenger candidates with weather being rainy are assigned priority 2, and other passenger candidates are assigned priority 1.

<Number of Times of Use>

For example, it is likely that the passenger candidate who has used the on-demand transportation vehicle 6 in the past also uses the on-demand transportation vehicle 6 this time. Therefore, different degrees of priority of use suggestion are assigned to passenger candidates who have used the on-demand transportation vehicle 6 in the past, and other candidates. Further, different degrees of priority are assigned according to the use frequency and the number of times of use of the on-demand transportation vehicle 6 in the past. For example, the priority is set so that the passenger candidates with higher use frequency are assigned priority 1, and the passenger candidates with lower use frequency are assigned priority 2. Further, the priority may be a function according to the use frequency.

<Age>

For example, a person accompanied by the elderly and an infant has difficulty in moving on foot or by using a private car, and a person under age also has difficulty in moving by driving a private car, and thus it is likely that such persons use the on-demand transportation vehicle 6. Therefore, a function assigning different degrees of priority of use suggestion according to age is used. The age can be calculated based on the member information of the IC card 3. For example, an absolute value of a value obtained by subtracting a predetermined value from the real age may be used. In this method, higher priority is assigned to the elderly and persons under age.

<Movement Distance>

For example, a tourist and a passenger candidate from far who have moved using the regularly-running transportation 5 have difficulty in moving by using a private car from the departure point S, also have difficulty in moving on foot if there are few or no acquaintances in the area, and it is assumed that there are many pieces of luggage, and thus it is likely that such persons use the on-demand transportation vehicle 6. Therefore, different degrees of priority of use suggestion are assigned to passenger candidates with a long distance between the departure point S and the address, passenger candidates with a long distance between the boarding station of the regularly-running transportation 5 and the departure point S, and other passenger candidates. For example, the passenger candidates with a long distance between the address or the boarding station and the departure point S are assigned priority 1, and other passenger candidates are assigned priority 2. Further, the priority may be a function according to the movement distance.

In the above example, the priority is set based on the distance between the address or the boarding station and the departure point S. However, the priority may be set based on a movement time period taken from the address or the boarding station to the departure point S. The movement time period taken from the boarding station to the departure point S can be calculated based on the timetable of the regularly-running transportation 5. The movement time period taken from the address to the boarding station can be calculated using an outdoor map, assuming that the movement is achieved on foot or by using other transportation means. In this manner, the priority may be a function according to the movement time period.

As described above, the candidate priority determination means 13 can determine the priority of the passenger candidates, based on indexes such as a destination, delay, weather, use frequency (number of times of use), age, and a movement distance (movement time period). Therefore, the priority is required to be determined based on comprehensive determination of each index. Accordingly, the candidate priority determination means 13 may determine the priority, based on a value (priority determination value) calculated by the following formula.

Priority determination value=w1×(priority according to destination)+w2×(priority according to delay)+w3×(priority according to weather)+w4×(priority according to use frequency)+w5×(priority according to age)+w6×(priority according to movement distance or movement time period)

Here, w1 to w6 are weight coefficients of the priority of each index, and can be set. This allows adjustment as to which index is weighted to determine the priority. Note that a part of the weight coefficients w1 to w6 may be set to 0, and no consideration may be required depending on an item, such as the season, for example.

For example, if the departure point S is a tourist site, it can be expected that tourists use the on-demand transportation vehicle 6, and thus the destination is less likely to be an address, and the movement distance is likely to be long. In this case, by reducing w1 and increasing w5, the use of the shared on-demand bus can be suggested to a larger number of tourists.

For example, if the departure point S is in a residential area, it is likely that the destination is an address, and the use of the on-demand transportation vehicle 6 in rainy weather can be expected. In this case, by increasing w1 and w3, the use of the on-demand transportation vehicle 6 can be suggested to a larger number of residents.

For example, if the departure point S is in a business district, it is likely that the destination is a workplace, and there is more anxiety concerning late arrival due to delay. In this case, by increasing w2, the use of the on-demand transportation vehicle 6 can be suggested to a larger number of workers.

In Step ST207 of FIG. 4, the third-passenger vehicle allocation planning means 19 creates a vehicle allocation plan for the passenger candidate (third passenger). The creation method of the vehicle allocation plan is similar to the creation method of Step ST006 of FIG. 2.

In Step ST208, the itinerary planning means 11 creates an itinerary, and transmits the created itinerary to the information terminal 2 of the passenger candidate (third passenger) via the transmission and reception means 4.

In Step ST209, the on-demand transportation management system 1 confirms whether the time has reached the reception end time of the itinerary request. If the time has reached the reception end time, the process proceeds to Step ST210, and the process returns to Step ST203 until the time reaches the reception end time.

In Step ST210, the fare calculation means 14 determines the fare for the passenger, based on an application method of the itinerary request of the passenger.

A reply indicating the use of the on-demand transportation vehicle 6 from the third passenger is required, and the reply needs to be waited for until the reception end time of the reply. If there is a reply indicating no use of the on-demand transportation vehicle 6 from the third passenger, a new third passenger who can be added to a vacant seat is searched, and the use is recommended for the new third passenger. Therefore, until the reception end time, Step ST203, Step ST204, Step ST205, and Step ST209 are repeated, and a reply from the third passenger is waited for.

In the vehicle allocation plan method of this example, there are three types of passengers, i.e., the first passengers, the second passengers, and the third passengers. Itinerary requests from the first passengers (high-priority passengers) satisfying a predetermined condition can be informed in advance, and thus the company of the shared on-demand transportation can create an efficient vehicle allocation plan of a limited number of on-demand transportation vehicles 6 for the first passengers. Here, the predetermined condition is that the on-demand transportation management system 1 receives the itinerary request before the predetermined time, and the desired arrival time or the desired departure time is within the predetermined period of time.

At the same time, not necessarily all the passengers can transmit the itinerary requests before the preset reception end time. Therefore, to have more passengers use the on-demand transportation vehicle 6, itinerary requests of the second passengers (general passengers) not satisfying the predetermined condition are also received.

There is not much time between the desired departure time or the desired arrival time and the current time for the second passenger. Therefore, vehicle allocation plans and itineraries need to be instantly created for intermittently transmitted itinerary requests of the second passengers. Depending on a case, an extra on-demand transportation vehicle 6 not allocated for the first passengers may be allocated for the second passengers. The vehicle allocation plan of the on-demand transportation vehicle 6 is not necessarily efficient in such a case.

In terms of efficient operation of the on-demand transportation vehicle 6, which is the property for the company of the shared on-demand transportation, the operation costs of the property for the second passengers are often higher than that for the first passengers. Therefore, for example, the fare for the first passengers is set lower than the fare for the second passengers.

Further, not necessarily all the passengers transmit the itinerary requests. To embrace potential demands and have more passengers use the on-demand transportation vehicle 6, the company of the shared on-demand transportation needs to pay attention to the third passengers. For the third passengers who do not transmit the itinerary requests on their own, however, there is not necessarily a high necessity for the on-demand transportation vehicle 6, and therefore a lower fare is set to stimulate the demand.

As described above, the departure point is a departure/destination point of the regularly-running transportation 5, the destination is an alighting point of the on-demand transportation vehicle 6, and the passenger candidate estimation means 12 estimates the passenger candidates in time for the departure time of the on-demand transportation vehicle 6 based on the use history, except the passengers from whom the itinerary requests have been already received, with a history reception means that receives a use history of the regularly-running transportation 5 used by the passenger candidates.

Further, the candidate priority determination means 13 determines priority of the passenger candidates by using at least any one of the destination, delay information of regularly-running transportation 5, weather information, boarding frequency according to the IC card 3, registered age in the IC card, a movement distance according to the regularly-running transportation 5, and a movement time period according to the regularly-running transportation 5.

For example, the use history of the regularly-running transportation 5 is use time of the IC card 3 that can be used as a ticket for the regularly-running transportation 5. Further, the use history of the regularly-running transportation 5 is boarding time for the regularly-running transportation 5 of the passenger candidate or entering time into the regularly-running transportation (for example, a station ticket gate or an entrance gate).

Further, the passenger candidate estimation means 12 estimates an alighting point where the passenger candidate alights from the regularly-running transportation 5, based on the use history of the regularly-running transportation 5.

Further, the passenger candidate estimation means 12 estimates time when the passenger candidate alights from the regularly-running transportation 5, by using operation information of the regularly-running transportation 5. Here, the operation information of the regularly-running transportation 5 includes delay information of the regularly-running transportation 5, as well as the timetable of the regularly-running transportation 5.

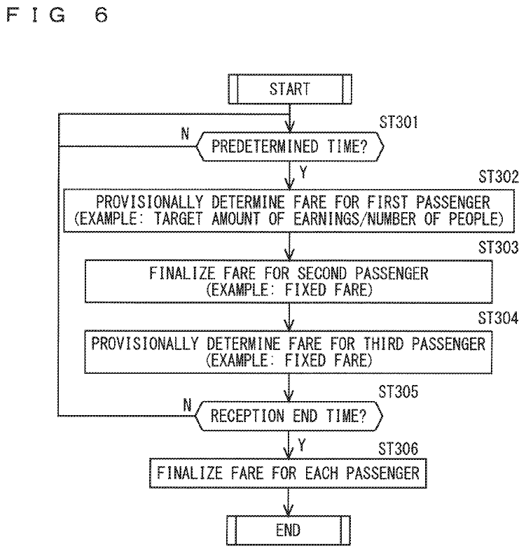

FIG. 6 is a diagram illustrating a fare calculation method used by the fare calculation means 14. For the sake of better understanding, the description herein assumes that passengers have the same movement time period and movement distance, without consideration of the difference in the movement time period and the movement distance from the departure point S to the destination of each passenger using the on-demand transportation vehicle 6. The on-demand transportation vehicle 6 is not assumed to run in a wide area, and thus the fare may be uniform for each passenger classification.

For example, when the time reaches the reception end time (predetermined time) for the itinerary request of the first passenger in Step ST301, the fare calculation means 14 provisionally determines the fare for the first passenger in Step ST302. For example, if there is a target amount of earnings to be made from the first passengers in terms of management of the on-demand transportation vehicle 6, a value obtained by dividing the amount of earnings by the number of first passengers is provisionally determined as the fare for the first passenger.

In Step ST303, the fare for the second passenger is determined. The fare for the second passenger is a fixed fare for the second passenger that is determined in advance.

In Step ST304, the fare for the third passenger is provisionally determined. The fare for the third passenger is a fixed fare for the third passenger that is determined in advance.

When the time reaches the reception end time of the on-demand transportation vehicle 6 and the number of boarding people for the on-demand transportation vehicle 6 is determined in Step ST305, in Step ST306, the fare calculation means 14 finalizes the provisionally determined fares for the first passenger and the third passenger. For example, the fares for the first passenger and the third passenger are discounted according to the number of boarding people.

Although this example assumes that a higher fare is assigned to the third passenger, the first passenger, and the second passenger in the descending order, but this is not necessarily restrictive. The method of determining the fare for each passenger can be changed according to a form of managing the on-demand transportation vehicle 6.

For example, the first passenger may not be fully satisfied when the fare for the second passenger is cheaper than the fare for the first passenger, in a comparison between the first passenger and the second passenger. This is because the first passenger transmits the itinerary request earlier. However, there are views on the second passenger and the third passenger regarding the fare. One view is that the fare for the third passenger is set high, and the fare for the second passenger is set low. This is based on a view that the fare for the one who actively transmits the itinerary request on their own will, even though the time is later than the predetermined time, is naturally as cheap as or cheaper than the fare for the third passenger who often transmits the itinerary request significantly later than the predetermined time.

The other view is that the fare for the second passenger is set high, and the fare for the third passenger is set low. The company of the shared on-demand transportation wishes to provide the service of the on-demand transportation vehicle 6 in the most efficient manner, for example, to provide the service with all or nearly all the seats filled rather than having vacant seats in the on-demand transportation vehicle 6. In an extreme case, the fare for the third passenger becomes closer to and equal to the fare of the first passenger. In such a case, a difference may be set, such as by having the third passenger use the auxiliary seat or having the second passenger use the window seat.

Further, in Step ST306, the fare calculation means 14 determines the fare for the passengers, based on the results of the passenger determination means 8. However, the fare for the passengers may be determined according to an elapsed time period from the preset reception end time (predetermined time) of the on-demand transportation vehicle 6 in Step ST301 to the departure time of the on-demand transportation vehicle 6. For example, the preset reception end time (predetermined time) of the on-demand transportation vehicle 6 in Step ST301 to the departure time of the on-demand transportation vehicle 6 is denoted by t. The fare may be calculated by using a function f(t) that shows monotonic increase or step-wise increase, or a function g(t) that shows monotonic decrease or step-wise decrease, according to the elapsed time period t.

The fare calculation means 14 assigns a fare of the on-demand transportation vehicle 6 so as to be different between the high-priority passenger satisfying the predetermined condition and the general passenger not satisfying the predetermined condition. Further, the fare calculation means 14 may assign a cheaper fare for the high-priority passenger as there are a larger number of general passengers, or may assign a more expensive fare for the general passenger as there are a larger number of high-priority passengers. Further, the fare calculation means 14 may calculate the fare for the general passenger, according to the difference between the reception time of the itinerary request of the general passenger and the predetermined time.

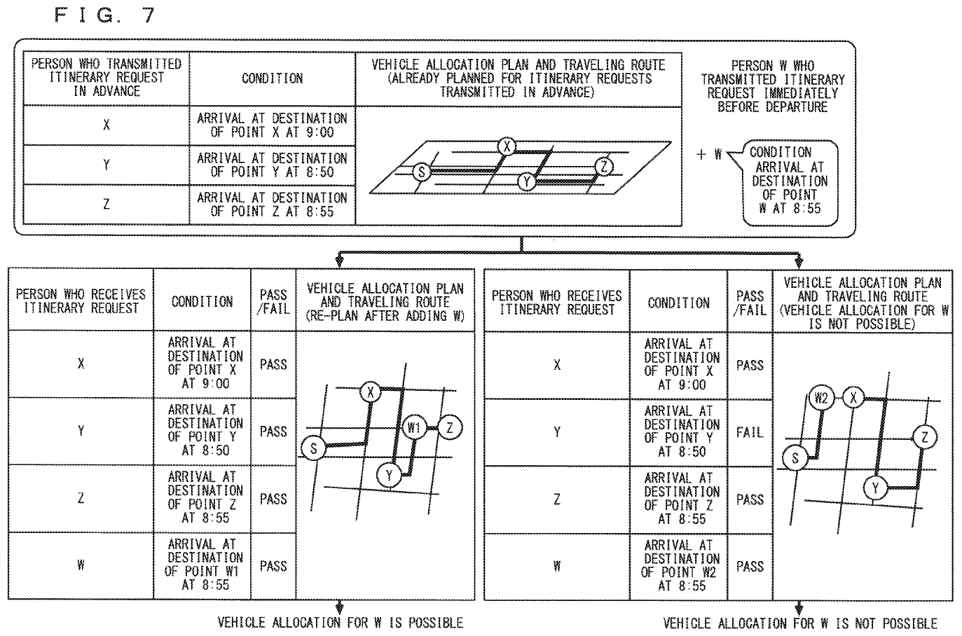

FIG. 7 is a conceptual diagram of a traveling route and a vehicle allocation plan. There are three persons, X, Y, and Z, as persons who transmitted the itinerary requests in advance, with the same departure point S. The condition is as follows: for their respective destinations, X desires to arrive at point X by 9 am, Y at point Y by 8:50 am, and Z at point Z by 8:55 am. The vehicle allocation plan and the traveling route of the on-demand transportation vehicle 6 for the advance itinerary requests of the three X, Y, and Z are already planned. The example illustrates a case where W transmits an itinerary request (arrival at point W at 8:55 am) immediately before the departure in the situation mentioned above (the upper diagram).

The lower diagrams are examples of attempting to re-plan the vehicle allocation plan and the traveling route after adding the itinerary request of W. In the example of the lower left diagram with the destination being W1, the vehicle allocation plan can be created. In contrast, in the example of the lower right diagram with the destination being W2, Y cannot arrive by the desired time, and the vehicle allocation plan is cannot be created. In this case, if the destination is W1, the itinerary request of W can be accepted, whereas if the destination is W2, the itinerary request cannot be accepted.

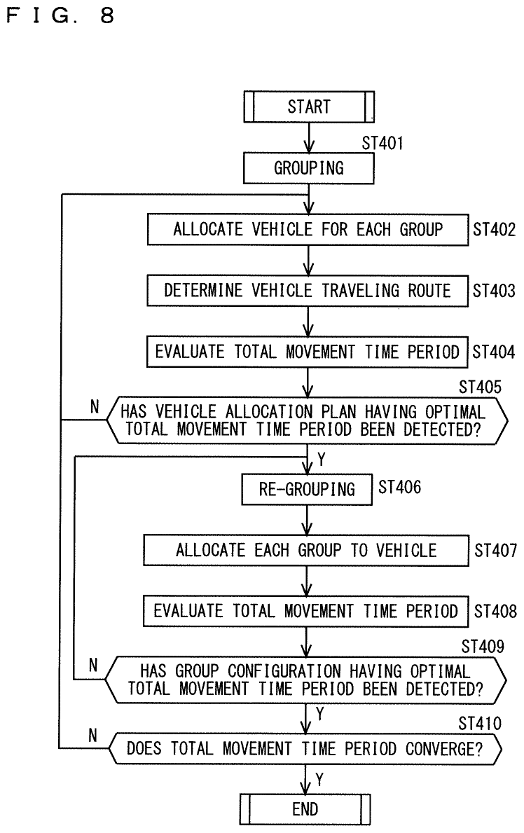

Next, a creation method of the vehicle allocation plan for the first passenger used by the first-passenger vehicle allocation planning means 9 in Step ST004 of FIG. 2 will be described. FIG. 8 is a diagram illustrating the creation method of the vehicle allocation plan used by the first-passenger vehicle allocation planning means 9.

As an example, the description herein takes an example of using an index of a minimum value of the total movement time period being a total time period taken for the first passenger to reach the destination from the departure point. Other than the above, a function using a time period taken for the high-priority passenger to reach the destination from the departure point may be one using at least one of the total movement time period, a total waiting time period required for transferring, and a total boarding time period.

Further, on-demand transportation vehicle efficiency may be used, in which the departure point is replaced by the departure point S of the on-demand transportation vehicle 6, the destination by the destination of the on-demand transportation vehicle 6, and the total time period by the traveling distance or the traveling time period of the on-demand transportation vehicle 6. In this case, the index is a minimum value of the traveling distance or the traveling time period between the departure point S and the final destination of the on-demand transportation vehicle 6.

In Step ST401, the grouping means 15 classifies the first passengers into a plurality of groups. For example, the first passengers are grouped and classified according to a specific rule, such as the same destination, close destinations, the same departure point, close departure points, close desired arrival times for a destination, and close desired departure times from a departure point. Note that although the term “group” is used, the “group” may herein consist of one person. Here, the process proceeds to Step ST402, with fixed groups of passengers A.

In Step ST402, the allocation means 16 allocates each group to the on-demand transportation vehicle 6.

In Step ST403, the traveling route planning means 17 determines a traveling route of each vehicle of the on-demand transportation vehicle 6. A route that starts from the departure point S of the on-demand transportation vehicle 6 and passes all the destinations (departure points S) included in the itinerary requests of the passengers constituting the allocated group is determined. A map for determining the route is held in advance, and the traveling distance and the traveling time period between the stop points can be acquired from the map.

For the determination of the route, determination may be made so as to optimize a specific index. Examples include a minimum value of the total boarding time period of each passenger, a minimum value of dispersed values of the boarding time period of each passenger, a minimum value of the total waiting time period of each passenger, a minimum value of dispersed values of the waiting time period of each passenger, a minimum value of the traveling time of the on-demand transportation vehicle 6, a minimum value of the traveling time period of the on-demand transportation vehicle 6, etc.

The number of indexes is not limited to one. For example, “Ca×total waiting time period of each passenger+Cb×traveling distance” may be minimized. Ca and Cb are weight coefficients, and adjust a variable in a different dimension in this example. In this manner, a route in consideration of the total waiting time period of the passenger and the traveling distance of the on-demand transportation vehicle 6 can be determined. Note that, to search for a route optimizing a specific index out of routes with a plurality of patterns, for example, an existing search method can be used, such as A* search (A-star search), which is one of best-first search methods.

Further, since the itinerary request of each passenger includes a condition such as the desired departure time from the departure point S and the desired arrival time for the destination, the determined route needs to satisfy the conditions of all the passengers constituting the group. A route that cannot satisfy the conditions is deemed inappropriate as a traveling route of the on-demand transportation vehicle 6. In this manner, the number of searched routes can be reduced, and an efficient search can be carried out.

Note that, in Step ST402 and Step ST403, passengers to board the on-demand transportation vehicle 6 and its traveling route are determined, and therefore the vehicle allocation plan of the on-demand transportation vehicle 6 is uniquely determined.

In Step ST404, the total movement time period prediction means 18 predicts a total of a total movement time period provided that each passenger moves according to the vehicle allocation plan determined in Step ST402 and Step ST403, and calculates the total movement time period. An ideal total movement time period is a total time period taken for a passenger to reach a destination from a departure point. The total movement time period is a total time period in the known range, although including a time period not known exactly. For example, the total movement time period includes a total of the boarding time period of the regularly-running transportation 5, the waiting time period of the on-demand transportation vehicle 6, and the boarding time period of the on-demand transportation vehicle 6. The total movement time period may include a movement time period to a boarding station of the regularly-running, and a movement time period taken from an alighting station of the regularly-running transportation 5 to a boarding point of the on-demand transportation vehicle 6.

The boarding time period of the on-demand transportation vehicle 6 is a boarding time period taken from a point of boarding the on-demand transportation vehicle 6 to a point of alighting from the on-demand transportation vehicle 6, and can be calculated by the traveling route planning means 17.

In the example in which the regularly-running transportation 5 is a train, time later than alighting time of the train by a movement time period taken from an alighting station of the train to a boarding point of the on-demand transportation vehicle 6 needs to be in time for the departure time of the on-demand transportation vehicle 6. Provided that the movement time period taken from an alighting station of the train to a boarding point of the on-demand transportation vehicle 6 can be calculated in advance using a map or the like, a train vehicle (i.e., the train vehicle R1 or R2) in time for the departure time of the on-demand transportation vehicle 6 can be calculated based on the timetable of the train. The starting station and the first departure time and arrival time for each stop of the train vehicle R1 or R2 can be calculated based on the timetable, and thus the boarding time period of the train vehicle of each passenger can be calculated based on the timetable.

The waiting time period of the on-demand transportation vehicle 6 can be calculated by further subtracting the movement time period taken from the alighting station of the train to the boarding point of the on-demand transportation vehicle 6 from time obtained by subtracting the arrival time for the alighting station of the train vehicle R1 from the departure time of the on-demand transportation vehicle 6.

In Step ST404, a train vehicle to be boarded by the passengers is determined, and therefore the itineraries of the passengers are uniquely determined, with a combination with the vehicle allocation plan of the on-demand transportation vehicle 6. Therefore, for the itinerary planning means 11, itinerary creation carried out in Step ST007 of FIG. 2 and Step ST202 and Step ST208 of FIG. 4 and Step ST404 of FIG. 8 are a similar method.

In Step ST405, the first-passenger vehicle allocation planning means 9 repeats the process from Step ST402 to Step ST404, fixes the groups of passengers A, and creates a provisional vehicle allocation plan according to a function using a time period taken to reach the destination from the departure point. For example, if a minimum value of the total movement time period is set as a target, the process proceeds to Step ST406 when a vehicle allocation plan that most minimizes the total movement time period through repetition of the process is obtained.

In Step ST406, the grouping means 15 classifies the passengers into other groups different from the groups of passengers when the vehicle allocation plan (itinerary) is determined in Step ST405. This is re-grouping of passengers.

In Step ST407, the allocation means 16 allocates each group to the on-demand transportation vehicle 6. Note that the traveling route of the on-demand transportation vehicle 6 is not changed in Step ST407, and thus the vehicle allocation plan determined in Step ST405 is used.

In Step ST408, the total movement time period prediction means 18 predicts a total movement time period of the passengers provided that each passenger moves according to the vehicle allocation plan determined in Step ST406 and Step ST407, and calculates a total of the total movement time period. The prediction method is the same method as in Step ST404. Note that in Step ST408, a train vehicle to be boarded by the passengers is determined, and therefore the itineraries of the passengers are uniquely determined, with a combination with the vehicle allocation plan of the on-demand transportation vehicle 6.

In Step ST409, the first-passenger vehicle allocation planning means 9 repeats the process from Step ST406 to Step ST408, fixes the vehicle allocation plan of the on-demand transportation vehicle 6, and calculates the groups of the first passengers according to a function using a time period taken to reach the destination from the departure point. For example, with the vehicle allocation plan being fixed, a group of first passengers that most minimizes the total movement time period is calculated, and the itinerary for each passenger is determined. Note that a group configuration and its vehicle allocation plan (itinerary) that cannot satisfy the conditions such as the desired arrival time and the desired departure time of the itinerary request of each passenger are deemed inappropriate as a vehicle allocation plan (itinerary).

Step ST402 to Step ST405 exemplifies a vehicle allocation plan having an optimal total movement time period with the fixed group, and Step ST406 to Step ST409 exemplifies grouping having an optimal total movement time period with the fixed vehicle allocation plan.

In Step ST410, the first-passenger vehicle allocation planning means 9 compares the vehicle allocation plan (itinerary) calculated in Step ST405 and the vehicle allocation plan (itinerary) calculated in Step ST409. If the total of the total movement time period calculated in Step ST405 is equal to or less than the total of the total movement time period calculated in Step ST409, creation of the vehicle allocation plan (itinerary) ends, regarding that the vehicle allocation plan (itinerary) that minimizes the total movement time period is calculated. If the total of the total movement time period calculated in Step ST405 is not equal to or less than the total of the total movement time period calculated in Step ST409, the process from Step ST402 is restarted for the group calculated in Step ST406.

The on-demand transportation vehicle 6 receives the vehicle allocation plan created by the on-demand transportation management system 1 from the transmission and reception means 4. Note that the vehicle allocation plan may be received via the management device of the on-demand transportation vehicle 6, instead of being directly received from the on-demand transportation management system 1. The vehicle allocation plan includes, for example, arrival time and departure time for each vehicle stop point, a traveling route between vehicle stop points, the number of passengers at each vehicle stop point, an identifier such as a name, gender, age, an alighting point, etc.

The passenger receives the itinerary created by the on-demand transportation management system 1 from the transmission and reception means 4 via the information terminal 2. The itinerary is information of a departure point S, departure time, a destination, scheduled arrival time, a fare, etc.

As described above, the on-demand transportation management system 1 classifies the passengers, according to a predetermined condition that the itinerary requests are received before the predetermined time, and the desired arrival time or the desired departure time is within the predetermined period of time, with the request reception means (transmission and reception means 4) that receives the itinerary requests of a plurality of passengers including at least one of the desired departure time and the desired arrival time of the on-demand transportation vehicle 6, the departure point, and the destination, and creates the vehicle allocation plan of the on-demand transportation vehicle 6.

Further, one of the departure point and the destination is a departure/destination point of the regularly-running transportation 5, and the other of the departure point and the destination is a departure/destination point of the on-demand transportation vehicle 6.

Further, the first-passenger vehicle allocation planning means 9 alternately repeats creation of a provisional vehicle allocation plan according to provisional grouping of high-priority passengers satisfying the predetermined condition and creation of a provisional vehicle allocation plan according to a function using a time period taken for the high-priority passenger to reach the destination from the departure point, and thereby creates the vehicle allocation plan.

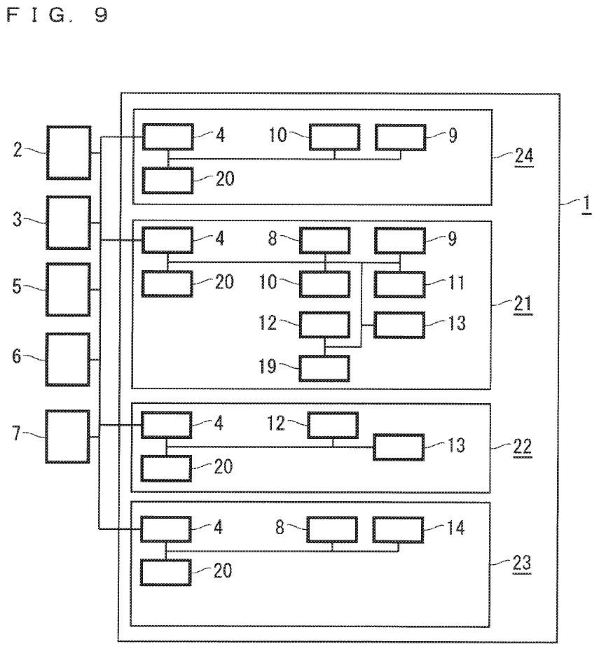

FIG. 9 is a block diagram of the on-demand transportation management system 1 according to the first embodiment. The figure is substantially the same block diagram as FIG. 1, but is rearranged from a different view point. Note that in the figures, parts denoted by the same reference signs are the same or equivalent parts, and this applies to the entire specification and all the figures of the drawings. Further, the forms of the components represented in the entire specification are merely illustrative, and are not limited to those in the description.

A passenger candidate estimation device 22 includes the passenger candidate estimation means 12, the candidate priority determination means 13, the database 20, and the transmission and reception means 4. The passenger candidate estimation device 22 receives member information of the IC card 3 including an identifier such as a member's name and a membership number, an address, a date of birth, age, contact information such as a telephone number and an e-mail address, a boarding station and an alighting station of a designated area of a commuter pass of the regularly-running transportation 5, a ticket gate passage history in stations, etc., from the IC card 3, a reading device or of the IC card 3, or an entrance/exit management device via the transmission and reception means 4. The passenger candidate estimation device 22 receives a position of a vehicle of the regularly-running transportation 5, a timetable, a running plan, delay information, a map, etc., from the regularly-running transportation 5 or a regularly-running transportation operation management device via the transmission and reception means 4. The passenger candidate estimation device 22 receives a use history of the on-demand transportation vehicle 6 from the on-demand transportation vehicle 6 or a management device of the on-demand transportation vehicle 6 via the transmission and reception means 4. The passenger candidate estimation device 22 receives weather in each area, temperature, probability of precipitation, the amount of precipitation, various advisories, various warnings, forecasts of those items, etc., from the weather information providing device 7 via the transmission and reception means 4.

The passenger candidate estimation device 22 may include the third-passenger vehicle allocation planning means 19. The passenger candidate estimation device 22 may further include the first-passenger vehicle allocation planning means 9, the second-passenger vehicle allocation planning means 10, the itinerary planning means 11, and the passenger determination means 8.

A vehicle allocation planning device 24 of the simplest configuration, which does not carry out passenger estimation, includes the first-passenger vehicle allocation planning means 9, the second-passenger vehicle allocation planning means 10, the database 20, and the transmission and reception means 4. In contrast, a vehicle allocation planning device 21, which carries out passenger estimation, includes the first-passenger vehicle allocation planning means 9, the second-passenger vehicle allocation planning means 10, the third-passenger vehicle allocation planning means 19, the passenger determination means 8, the itinerary planning means 11, the passenger candidate estimation means 12, the candidate priority determination means 13, the database 20, and the transmission and reception means 4. Although the vehicle allocation planning device 21 includes many components, unnecessary components can be omitted according to a purpose.

The vehicle allocation planning device 21 receives an itinerary request including information such as a destination, a departure point, desired arrival time, desired departure time, a boarding station, and an alighting station, from the information terminal 2 via the transmission and reception means 4. The vehicle allocation planning device 21 receives a position of a vehicle of the regularly-running transportation 5, a timetable, a running plan, delay information, a map, etc., from the regularly-running transportation 5 or a regularly-running transportation operation management device via the transmission and reception means 4. The vehicle allocation planning device 21 receives a position of a vehicle of the on-demand transportation vehicle 6, a running plan, delay information, a map, etc., from the on-demand transportation vehicle 6 or a shared on-demand transportation management device via the transmission and reception means 4. The vehicle allocation planning device 21 estimates passenger candidates (third passengers) and determines priority of the passenger candidates, by using the passenger candidate estimation means 12 and the candidate priority determination means 13.

The on-demand transportation vehicle 6 receives the vehicle allocation plan created by the vehicle allocation planning devices 21 and 24. Note that the vehicle allocation plan may be received via the management device of the on-demand transportation vehicle 6, instead of being directly received from the vehicle allocation planning devices 21 and 24. The vehicle allocation plan includes, for example, arrival time and departure time for each vehicle stop point, a traveling route between vehicle stop points, the number of passengers at each vehicle stop point, an identifier such as a name, gender, age, and an alighting point, etc.

The passenger receives the itinerary created by the vehicle allocation planning devices 21 and 24 from the transmission and reception means 4 via the information terminal 2. The itinerary is information of a departure point S, departure time, a destination, scheduled arrival time, a fare, etc.

A fare calculation device 23 includes the fare calculation means 14, the passenger determination means 8, the database 20, and the transmission and reception means 4. The fare calculation device 23 receives a boarding station of the regularly-running transportation boarded by each person, departure time thereof, an alighting station thereof, arrival time thereof, a boarding point of the on-demand transportation vehicle 6 to be boarded, an identifier of a vehicle thereof, departure time thereof, an alighting point thereof, arrival time thereof, an itinerary request, etc., from the vehicle allocation planning device or the on-demand transportation management system 1. The fare calculation device 23 receives the vehicle allocation plan for each passenger from the vehicle allocation planning device. The fare calculation device 23 receives the itinerary request from the information terminal 2. The passenger receives the fare created by the fare calculation device 23 from the transmission and reception means 4 via the information terminal 2.

The fare calculation device 23 may further include the first-passenger vehicle allocation planning means 9, the second-passenger vehicle allocation planning means 10, the itinerary planning means 11, the passenger candidate estimation means 12, and the candidate priority determination means 13, if necessary.

Note that although constituent means of the vehicle allocation planning devices 21 and 24, the passenger candidate estimation device 22, and the fare calculation device 23 are illustrated as an example, the number of such constituent means can be increased or decreased as appropriate as long as they are the constituent means described in the on-demand transportation management system 1, and these configurations are not restrictive. Further, each means, including the on-demand transportation management system, may be incorporated into a device that can implement the means. Information necessary for implementation may be received from another device holding the information.

Further, according to the first embodiment of the present invention, although a created itinerary for a passenger is transmitted to the passenger, the passenger is not necessarily satisfied with the created itinerary and its fare. In view of this, a reply indicating acceptance/rejection concerning the transmitted itinerary may be received from the passenger. Only when a reply indicating acceptance is received, the itinerary and the vehicle allocation plan are confirmed. In this case, reception end time for the acceptance/rejection reply may be provided. If there is no reply even after the reception end time, it is not accepted.

Further, according to the first embodiment of the present invention, a created itinerary is also transmitted to the third passenger. However, unlike the first passenger and the second passenger, the passenger themselves does not transmit the itinerary request, and thus contact information as a transmission destination of the itinerary may be unknown. In view of this, as the contact information of the third passenger, contact information (such as an e-mail address and a telephone number) included in the member information of the IC card 3 may be used. In this case, in advance, the member of the IC card 3 permits the use of the contact information included in the member information of the IC card 3 as a transmission destination of the itinerary in advance.

According to the above, by classifying the first passengers and the second passengers and separately creating vehicle allocation plans, a limited number of on-demand transportation vehicles 6 can be efficiently operated, and at the same time, a vehicle allocation plan receiving itinerary requests of a larger number of passengers can be created.

Further, by detecting passengers based on the use history of the regularly-running transportation 5 and suggesting shared riding, the on-demand transportation can be used by a larger number of passengers.

Further, by classifying passengers into passengers who transmitted itinerary requests before the preset reception end time, passengers who transmitted itinerary requests after the preset reception end time of the itinerary requests, and passengers detected by the company of the shared on-demand transportation and who use the shared on-demand transportation, and assigning different fares according to a method of applying for the use of the on-demand transportation of the passenger, the demand for the on-demand transportation can be stimulated, and the on-demand transportation can be used by a larger number of passengers.

Further, since the regularly-running transportation 5 has the first operation and the final operation, it is likely that the longer the passenger uses the regularly-running transportation 5 (higher the degree the passenger thinks that the first operation is late and the final operation is early), the less an itinerary combining the regularly-running transportation 5 and the on-demand transportation vehicle 6 can be created. According to the first embodiment of the present invention, by creating the vehicle allocation plan so as to minimize the total movement time period, the on-demand transportation vehicle 6 can be used by a larger number of passengers.

The invention of the present application is not limited to the embodiment described above, and can be variously modified within the scope of the invention of the present application. Specifically, the configuration of the embodiment described above can be modified as appropriate, or at least a part may be replaced by another configuration. Further, components whose arrangement is not particularly specified are not restricted to the arrangement disclosed in the embodiment, and can be arranged in a position enabling fulfillment of its function. Further, the plurality of components disclosed in the embodiment described above may be combined as appropriate to implement the invention. Further, the invention of the present application is defined by the claims instead of the scope of the embodiment described above, and encompasses all the modifications made within the claims and the equivalent meaning and scope.

### EXPLANATION OF REFERENCE SIGNS

1 on-demand transportation management system, 2 information terminal, 3 IC card, 4 transmission and reception means, 5 regularly-running transportation, 6 on-demand transportation vehicle, 7 weather information providing device, 8 passenger determination means, 9 first-passenger vehicle allocation planning means, 10 second-passenger vehicle allocation planning means, 11 itinerary planning means, 12 passenger candidate estimation means, 13 candidate priority determination means, 14 fare calculation means, 15 grouping means, 16 allocation means, 17 traveling route planning means, 18 total movement time period prediction means, 19 third-passenger vehicle allocation planning means, 20 database, 21 vehicle allocation planning device, 22 passenger candidate estimation device, 23 fare calculation device, 24 vehicle allocation planning device

1-17. (canceled)

18: An on-demand transportation management system including a processor to execute processes of:
receiving an itinerary request of a plurality of passengers, the itinerary request including at least any one of desired departure time and desired arrival time of an on-demand transportation vehicle, a departure point, and a destination;
receiving a use history of a regularly-running transportation used by a passenger candidate; and
estimating the passenger candidate in time for departure time of the on-demand transportation vehicle based on the use history, wherein
the departure point is a departure/destination point of the regularly-running transportation, and
the destination is an alighting point of the on-demand transportation vehicle.

19: The on-demand transportation management system according to claim 18, wherein
the processor determines order of suggesting use of the on-demand transportation vehicle among the estimated passenger candidate.

20: The on-demand transportation management system according to claim 19, wherein
the processor determines priority of the passenger candidate by using at least any one of a destination, delay information of the regularly-running transportation, weather information, boarding frequency according to an IC card, registered age in the IC card, a movement distance according to the regularly-running transportation, and a movement time period according to the regularly-running transportation.

21: The on-demand transportation management system according to claim 18, wherein
the use history is use time of an IC card that can be used as a ticket for the regularly-running transportation.

22: The on-demand transportation management system according to claim 18, wherein
the use history is boarding time for the regularly-running transportation of the passenger candidate or entering time into the regularly-running transportation.

23: The on-demand transportation management system according to claim 18, wherein
the processor estimates an alighting point where the passenger candidate alights from the regularly-running transportation, based on the use history.

24: The on-demand transportation management system according to claim 18, wherein
the processor estimates time when the passenger candidate alights from the regularly-running transportation, by using operation information of the regularly-running transportation.

25: The on-demand transportation management system according to claim 21, wherein
if the use time of the IC card at the departure point is earlier than time when a first regularly-running transportation departs from the departure point by a first predetermined time period, and the departure time of the on-demand transportation vehicle is later than time when the first regularly-running transportation arrives at a departure point of the on-demand transportation vehicle by a second predetermined time period, the processor classifies a user of the first regularly-running transportation as a first passenger candidate.

26: The on-demand transportation management system according to claim 25, wherein
if the use time of the IC card at the departure point is earlier than time when a second regularly-running transportation departs from the departure point by a third predetermined time period, the second regularly-running transportation departs from the departure point earlier than the first regularly-running transportation, and the departure time of the on-demand transportation vehicle is later than time when the second regularly-running transportation arrives at the departure point of the on-demand transportation vehicle by a fourth predetermined time period, the processor removes a user of the second regularly-running transportation from the first passenger candidate.

27: The on-demand transportation management system according to claim 18, wherein
the processor further creates a vehicle allocation plan of the on-demand transportation vehicle by classifying the plurality of passengers according to a predetermined condition that the itinerary request is received before predetermined time and the desired arrival time or the desired departure time is within a predetermined period of time.

28: The on-demand transportation management system according to claim 27, wherein
the processor calculates the vehicle allocation plan by grouping high-priority passengers satisfying the predetermined condition, creating a provisional vehicle allocation plan according to a function using a time period taken by each of the high-priority passengers to reach the destination from the departure point, further grouping the high-priority passengers according to the function using the time period taken by each of the high-priority passengers to reach the destination from the departure point in the provisional vehicle allocation plan, and alternately repeating the creation of the provisional vehicle allocation plan and the further grouping to converge the vehicle allocation plan.

29: The on-demand transportation management system according to claim 28, wherein
the function is a function using at least one of a total movement time period, a total waiting time period required for transferring, and a total boarding time period.
